(19) United States
(12) Patent Application Publication
(10) Pub. No.: US 2014/0089260 A1
(43) Pub. Date: Mar. 27, 2014

(54) WORKLOAD TRANSITIONING IN AN IN-MEMORY DATA GRID

(71) Applicant: INTERNATIONAL BUSINESS MACHINES CORPORATION, Armonk, NY (US)

(72) Inventors: Dustin K. Amrhein, Zachary, LA (US); Douglas C. Berg, Rochester, MN (US); Nitin Gaur, Round Rock, TX (US); Christopher D. Johnson, Rochester, MN (US)

(73) Assignee: INTERNATIONAL BUSINESS MACHINES CORPORATION, Armonk, NY (US)

(21) Appl. No.: 13/628,342

(22) Filed: Sep. 27, 2012

(51) Int. Cl. G06F 17/30

(52) U.S. Cl. 707/615; 707/E17.001

(57) ABSTRACT

Embodiments of the present invention disclose a method, system, and computer program product for transitioning a workload of a grid client from a first grid server to a second grid server. A replication process is commenced transferring application state from the first grid server to the second grid server. Prior to completion of the replication process: the grid client is rerouted to communicate with the second grid server. The second grid server receives a request from the grid client. The second grid server determines whether one or more resources necessary to handle the request have been received from the first grid server. Responsive to determining that the one or more resources have not been received from the first grid server, the second grid server queries the first grid server for the one or more resources. The second grid server responds to the request from the grid client.

### FIELD OF THE INVENTION

The present invention relates generally to the field of grid computing, and more particularly, to transferring a workload in an in-memory data grid.

### BACKGROUND OF THE INVENTION

An in-memory data grid (IMDG) is a distributed cache with data stored in memory to speed application access to data. An IMDG can dynamically cache, partition, replicate, and manage application data and business logic across multiple servers, thereby enabling data-intensive applications to process high volumes of transactions with high efficiency and linear scalability. IMDGs also provide high availability, high reliability, and predictable response times.

An IMDG supports both a local cache within a single virtual machine and a fully replicated cache distributed across numerous cache servers. As data volumes grow or as transaction volume increases, additional servers can be added to store the additional data and ensure consistent application access. Additionally, an IMDG can be spread through an entire enterprise to guarantee high availability. If a primary server fails, a replica is promoted to primary automatically to handle fault tolerance and ensure high performance.

### SUMMARY

Embodiments of the present invention disclose a method, computer program product, and system for transitioning a workload of a grid client from a first grid server to a second grid server. A replication process is commenced transferring application state from the first grid server to the second grid server. Prior to completion of the replication process: the grid client is rerouted to communicate with the second grid server. The second grid server receives a request from the grid client. The second grid server determines whether one or more resources necessary to handle the request have been received from the first grid server. Responsive to determining that the one or more resources have not been received from the first grid server, the second grid server queries the first grid server for the one or more resources. The second grid server responds to the request from the grid client.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 depicts a detailed implementation of an in-memory data grid, in accordance with an illustrative embodiment of the present invention.

FIG. 3A illustrates a grid client accessing an in-memory data grid via a catalog service providing routing information to a java virtual machine (JVM).

FIG. 3B depicts an immediate transition of a replica JVM to act as the primary server, in accordance with an illustrative embodiment of the present invention.

FIG. 4A depicts operational steps of a catalog service routing process implementing a transition of workload to a new JVM, in accordance with one embodiment of the present invention.

FIG. 4B depicts operational steps of a new JVM transitioning process, according to one embodiment of the present invention.

FIG. 5 depicts a block diagram of components of a data processing system, representative of any of the computing systems making up a grid computing system, in accordance with an illustrative embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

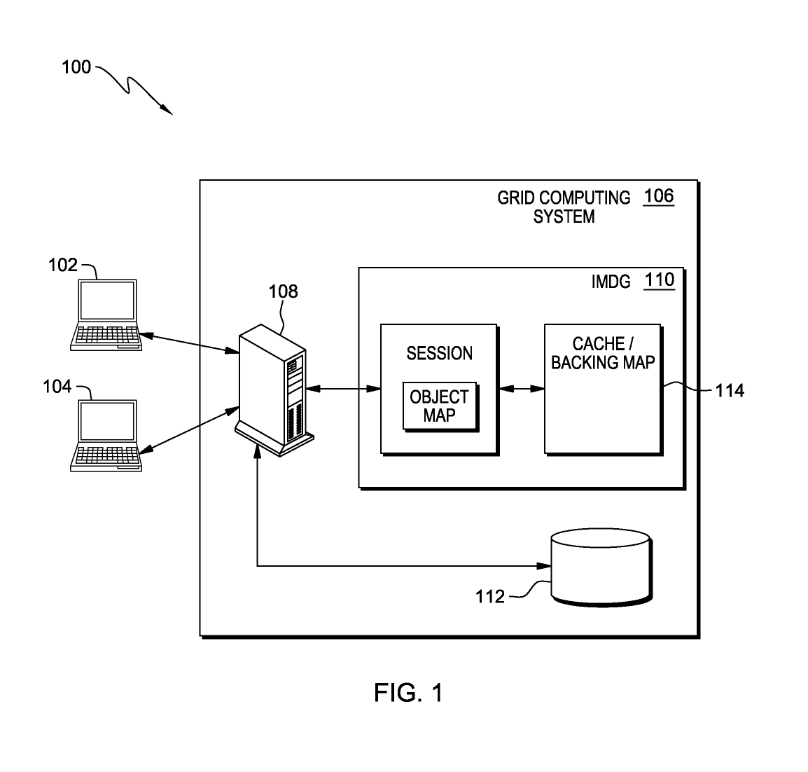

The present invention will now be described in detail with reference to the Figures. FIG. 1 is a functional block diagram illustrating a distributed data processing environment, generally designated 100, in accordance with one embodiment of the present invention. Distributed data processing environment 100 depicts client computers 102 and 104 interacting with grid computing system 106. Grid computing system 106 represents a collection of resources including computing systems and components, which are interconnected through various connections and protocols and, in one embodiment, may be at least nominally controlled by a single group or entity (e.g., an enterprise grid). In an exemplary implementation, the computing systems of grid computing system 106 may be organized into a set of processes or virtual machines, typically Java® virtual machines (JVMs), that can implement one or more application servers, such as application server 108, and an in-memory data grid (e.g., IMDG 110). In certain instances application server 108 may be considered a part of IMDG 110. Persons skilled in the art will recognize that in some embodiments a single JVM may host both an application and memory for IMDG 110. It will be understood that each computing system making up grid computing system 106 may be a server computer, mainframe, laptop computer, tablet computer, netbook computer, personal computer (PC), a desktop computer, or any programmable electronic device capable of communicating with other programmable electronic devices, and additionally, each computing system may host one or more virtual machines.

Application server 108 hosts application logic. Application servers may also be referred to as “grid clients.” Though depicted in FIG. 1 as a single cache entity, IMDG 110 may be comprised of interconnected JVMs that provide address space to store objects sought by application server 108. The virtual machines or processes making up IMDG 110 may be referred to as “grid servers.” By holding data in memory over multiple resources, IMDG 110 enables faster data access, ensures resiliency of the system and availability of the data in the event of a server failure, and reduces the stress on the back-end (physical) databases, e.g., database 112. The set of grid servers allows IMDG 110 to act like a single cache entity that can be used for storing data objects and/or application state.

IMDG 110 stores data objects using key-value pairs within map objects. Data can be put into and retrieved from an object map within the scope of a transaction using standard mapping methods. The map can be populated directly by an application, or it can be loaded from an external or back-end store. Using distributed data processing system 100 as an illustrative example, client computer 102 may access an application on application server 108. The application interacts with IMDG 110 on behalf of client computer 102 and may establish a session for client computer 102. Within the course of the session, the application may to attempt to retrieve a specific object from IMDG 110. If this is the first time the specific object has been requested, the query will result in a cache miss, because the object is not yet present in IMDG 110. The application may then retrieve the object from back end database 112 and use an “insert” to place the object into backing map 114 of IMDG 110. Backing map 114 is a map that contains cached objects that have been stored in the grid. The session's object map is committed to backing map 114 and the object is returned to application server 108 (and potentially to client computer 102). If the object already exists in the cache, for example if client computer 104 accesses the application subsequent to the preceding transaction, a new session may be created, and now a query will result in a cache hit. The object may now be located in memory via backing map 114 and returned to application server 108.

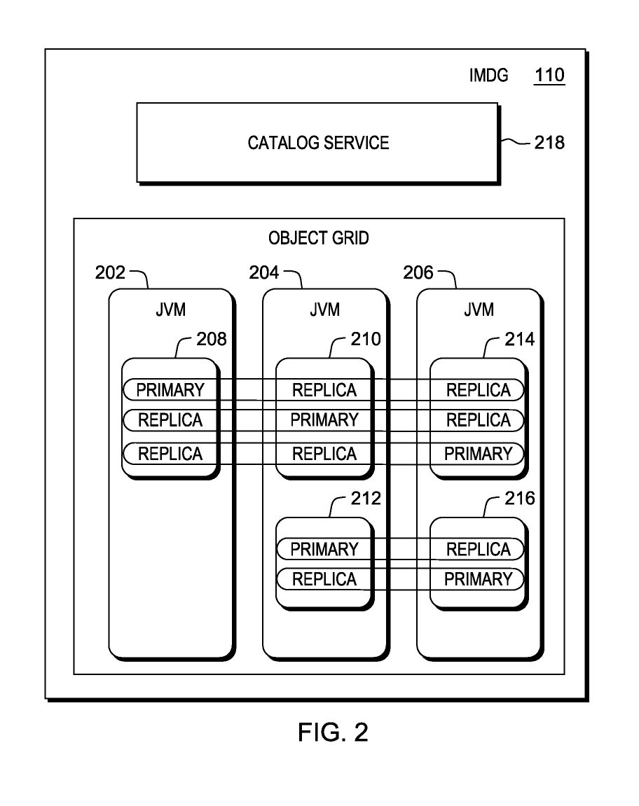

FIG. 2 depicts a more detailed implementation of IMDG 110, in accordance with an illustrative embodiment of the present invention. In FIG. 2, IMDG 110 is comprised of a plurality of JVMs, including JVM 202, JVM 204, and JVM 206. Each JVM is capable of hosting one or more “grid containers” that can be used to cache data objects and application state. A grid container holds data in a collection of maps, which taken collectively, for example, would make up backing map 114 of FIG. 1. As depicted, JVM 202 hosts a single grid container, grid container 208; and JVMs 204 and 206 each host two grid containers, grid containers 210 and 212 for JVM 204, and grid containers 214 and 216 for JVM 206. A person of skill in the art will recognize that in various embodiments any number of JVMs may exist, each holding any number of grid containers.

Stored data may be partitioned into smaller sections. Each partition is made up of a primary shard and zero or more replica shards distributed across one or more additional grid containers. FIG. 2 shows three partitions across grid containers 208, 210, and 214, with each partition having one primary shard and two replica shards; and two additional partitions across grid containers 212 and 216, each partition having a primary shard and a single replica shard.

In addition to JVMs acting as grid servers, IMDG 110 also includes catalog service 218 comprised of one or more catalog servers (typically JVMs). When a grid server starts up, it registers with catalog service 218. Catalog service 218 manages how the partition shards are distributed, monitors the health and status of grid servers, and enables grid clients to locate the primary shard for a requested object.

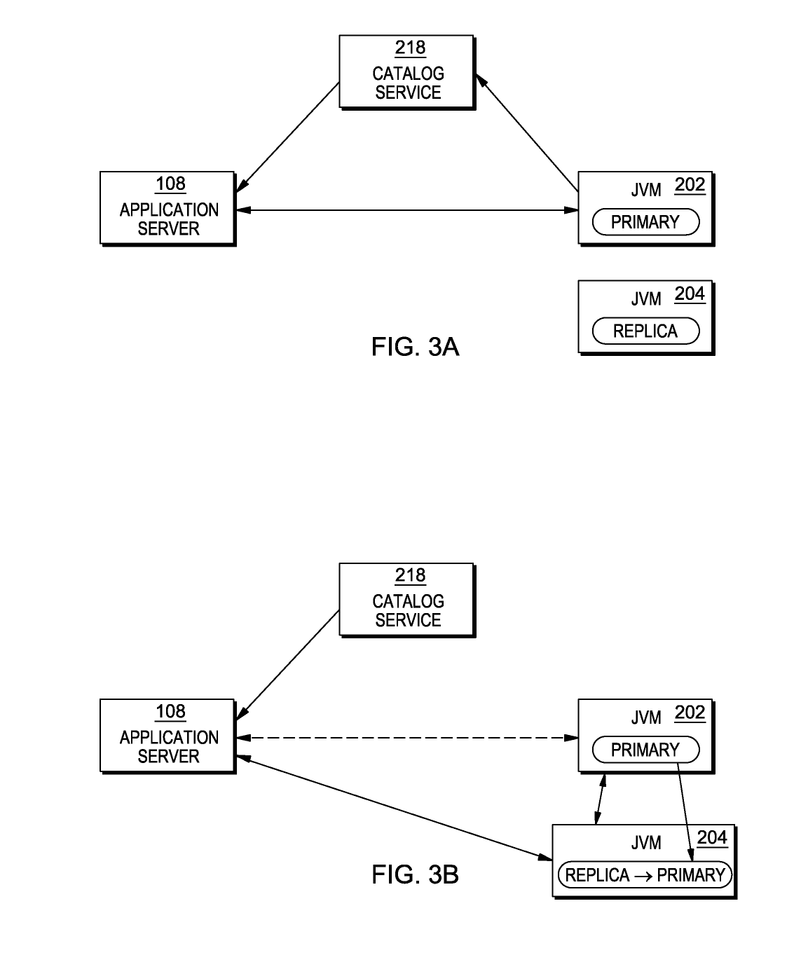

During operation, a grid client, such as application server 108, accesses IMDG 110 via a catalog service, such as catalog service 218, and the catalog service provides routing information to the grid client enabling it to access the JVM hosting the primary shard (referred to herein as the “primary server”). FIG. 3A depicts such a scenario. JVM 202 has communicated to catalog service 218 its availability. Catalog service 218 manages how partition shards are distributed and is aware of a primary shard hosted by JVM 202 (in grid container 208). Application server 108 accesses catalog service 218 and, based on the specifics of the application hosted by application server 108, catalog service 218 provides routing information to a primary shard, in this case the primary shard in grid container 208, and application server 108 connects to JVM 202 for execution/processing of its session workload. During the course of the session, application server 108 may request one or more objects, update one or more objects, and store application state information. JVM 204 hosts a replica shard in grid container 210.

Current IMDG design provides a mechanism to transition a workload from one process (JVM) to another. This may desirable during a failure event or other malfunctioning in the JVM, or if a new JVM is added to the IMDG. Using the described connection scenario of FIG. 3A, the current mechanism would begin transferring application state from JVM 202 to JVM 204 while JVM 202 continues to process the workload. Depending on whether data objects stored in the data partition are synchronously or asynchronously replicated, objects updated on JVM 202 by the application may also be transferred. Eventually JVM 204 catches up with the state of JVM 202 and a synchronized replication begins to keep the two processes in lock step. At this point, the workload may be transferred over to JVM 204 (catalog service 218 may update the replica shard on JVM 204 to be the primary shard and re-routes application server 108 to communicate with JVM 204) and the session may continue seamlessly. Without such a process, an entire session may need to be restarted on the replica.

Embodiments of the present invention recognize that, in certain instances, it may be desirable to transition the workload as quickly as possible—for example, if JVM 202 is experiencing problems or misbehaving in some way. In another scenario, in an under-provisioned grid, it may be beneficial to have a newly added server start handling workload as soon as possible. FIG. 3B depicts an immediate transition of JVM 204 to act as the primary server, in accordance with an illustrative embodiment of the present invention.

Catalog service 218 directs application server 108 to use JVM 204 as the primary server prior to the completion of any replication process. Catalog service 218 notifies JVM 204 of its new role and additionally of the previous primary JVM, in this case JVM 202. JVM 202 begins the process of replicating application state to JVM 204 as normal. As requests come into JVM 204 from application server 108, JVM 204 will determine if it has the current data and state information from JVM 202 relevant to the request and if it does not, JVM 202 will act as a proxy, querying JVM 202 for the relevant information. Meanwhile, the standard transitioning replication process from JVM 202 to JVM 204 continues. Thus, at the start of the transition process, JVM 202 experiences a near normal workload—though still no more that one request for each missed entry on JVM 204, thereby maintaining consistency. As JVM 204 nears complete replication, it will handle more requests from application server 108 directly, and less traffic will touch JVM 202. This process continues until the transition is complete. As such, the workload is transitioned away from JVM 202 in a quick and efficient manner.

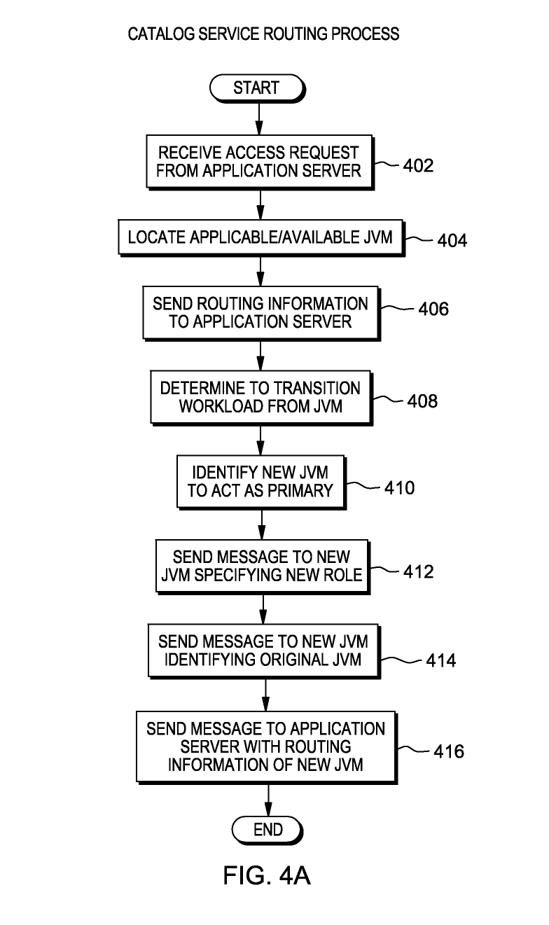

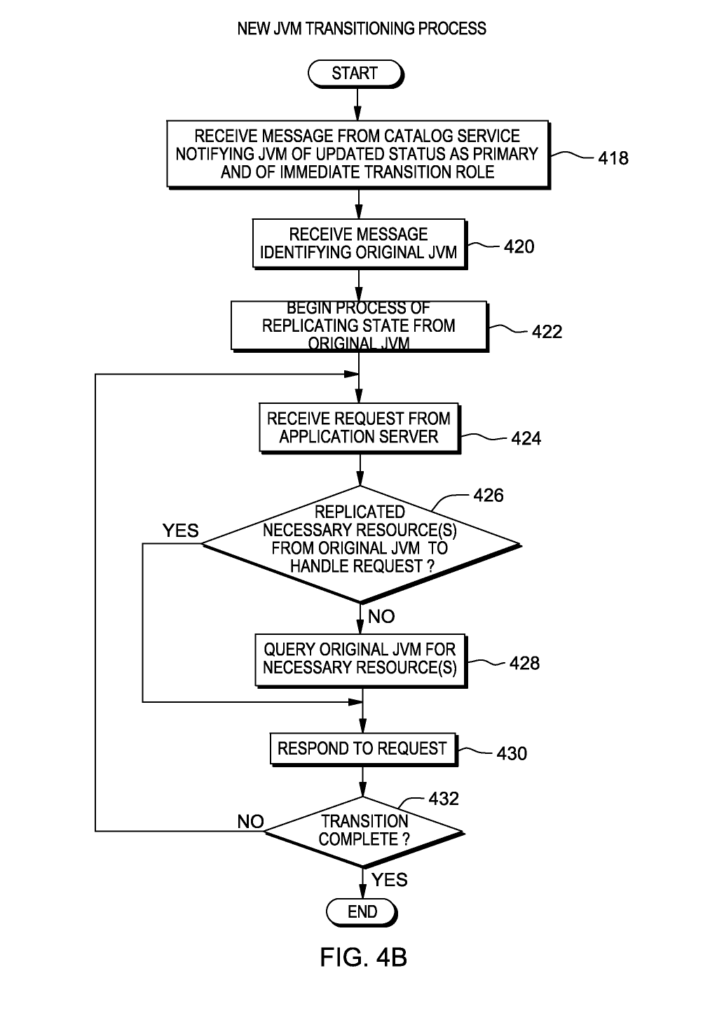

FIG. 4A depicts operational steps of a catalog service routing process implementing a transition of workload to a new JVM, in accordance with one embodiment of the present invention.

Catalog service 218 receives an access request from application server 108 (step 402), locates the applicable JVM (step 404), and sends the routing information for the JVM to the application server (step 406). As the applicable JVM (e.g., JVM 202) handles the workload from application server 108, catalog service 218 may, in some instances, determine that the workload should be transitioned away from the JVM (step 408). Catalog service 218 monitors the health of JVMs and may encounter an error or an unexpected event from the JVM. Alternatively, a newly added JVM may register with catalog service 218, and catalog service 218 may decide to offload work to the newly registered JVM.

Catalog service 218 subsequently identifies a new JVM to act as primary (step 410). A person of skill in the art will recognize that the process may be devoid of this step where the transition is occurring responsive to the registration of a new JVM. Generally speaking, catalog service 218 will select a JVM hosting a replica shard, e.g., JVM 204, and handling the least amount of work. Catalog service 218 sends a message to the new JVM specifying the new role (step 412). For example, catalog service 218 may notify the new JVM that it is the new primary server and that the transition will take place prior to a complete replication of application state. Catalog service 218 may also send a message to the new JVM identifying the original JVM (step 414), or the routing information for the original JVM, so that the new JVM may subsequently query the original JVM for any necessary information. Catalog service 218 informs application server 108 of the updated routing information (step 416), directing the application server to the new JVM.

FIG. 4B depicts operational steps of the new JVM transitioning process, according to one embodiment of the present invention.

The new JVM receives a message from the catalog service notifying the JVM of its updated status as the primary server and of the immediate transition (step 418). The new JVM may also receive a notification of the original JVM (step 420). The new JVM begins the process of replicating application state from the original JVM (step 422). In an alternative embodiment the original JVM may initiate the replication process. In some embodiments, for example, where the new JVM is a JVM that has just been added to the grid, the replication process may include mapped data objects as well as application state.

The new JVM may subsequently receive a request from the application server (step 424). The new JVM determines if it has replicated the necessary resource(s) (e.g., state information, objects) from the original JVM to handle the request (decision 426). If the new JVM has not replicated the necessary resource(s) (no branch, decision 426), the new JVM queries the original JVM for the resource(s) (step 428). If the new JVM does have the necessary resource(s) (yes branch, decision 426), or subsequent to querying the original JVM for the resource(s), the new JVM responds to the request (step 430). The new JVM determines whether the transition from the original JVM has completed (decision 432), and until the transition completes, continues to receive and handle requests from the application server in this manner (returns to step 424).

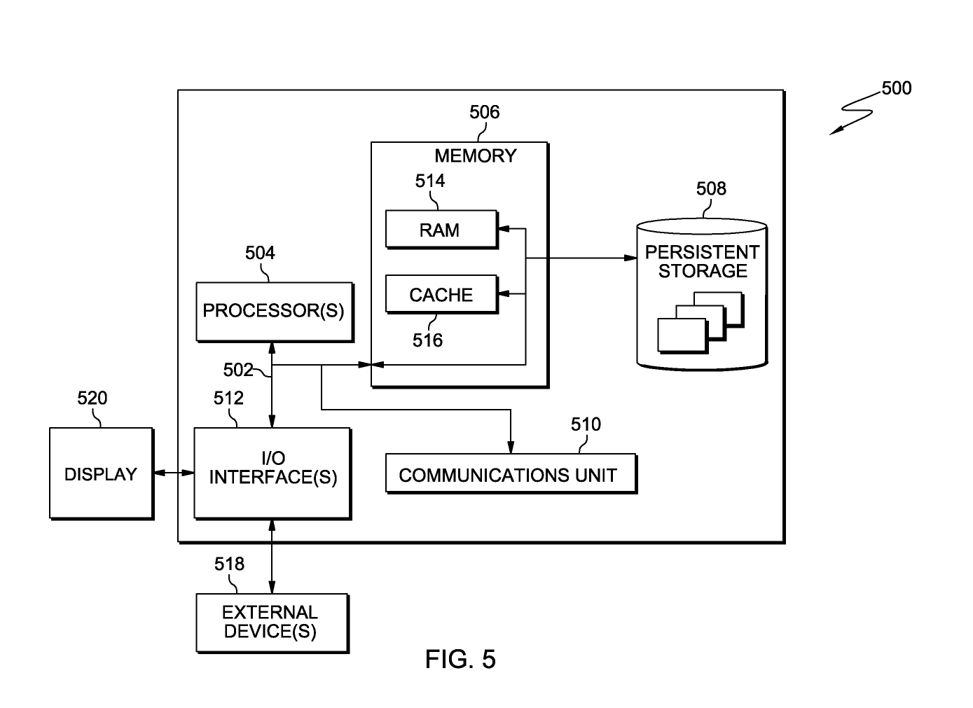

FIG. 5 depicts a block diagram of components of data processing system 500, representative of any of the computing systems making up grid computing system 106, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Data processing system 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media. Memory 506 and persistent storage 508 may be logically partitioned and allocated to one or more virtual machines. Memory allocated to a virtual machine may be communicatively coupled to memory of other virtual machines to form an in-memory data grid.

Computer programs and processes are stored in persistent storage 508 for execution by one or more of the respective computer processors 504 via one or more memories of memory 506. For example, processes implementing virtual machines may be stored in persistent storage 508, as well as applications running within the virtual machines, such as an application of application server 108, routing processes on catalog service 218, and transitioning processes on JVM 204. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including other computing systems of grid computing system 106 and client computers 102 and 104. In these examples, communications unit 510 includes one or more network interface cards. Communications unit 510 may provide communications through the use of either or both physical and wireless communications links. Computer programs and processes may be downloaded to persistent storage 508 through communications unit 510.

I/O interface(s) 512 allows for input and output of data with other devices that may be connected to data processing system 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 508 via I/O interface(s) 512. I/O interface(s) 512 may also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for transitioning a workload of a grid client from a first grid server to a second grid server within a grid computing system, the method comprising:
in response to a determination to transfer the workload of the grid client from the first grid server to the second grid server, wherein the first grid server contains a plurality of separate partitions corresponding to different workloads including a first partition for the workload of the grid client, a catalog server designating a corresponding partition on the second grid server as a primary partition for the workload of the grid client such that the second grid server responds directly to requests from the grid client utilizing the primary partition and seeks data from the first partition on the first grid server if a request cannot be completed due to the primary partition not having current live data;
commencing a replication process transferring data from the first partition on the first grid server to the primary partition on the second grid server;
prior to completion of the replication process:
the catalog server rerouting the grid client to communicate with the second grid server;
receiving a request at the second grid server from the grid client;
determining, by the second grid server, whether one or more resources necessary to handle the request are current in the primary partition corresponding to the workload of the grid client;
responsive to determining that the one or more resources are not current, based on an identity of the grid client and information received from the catalog server, the second grid server identifying the first grid server, from a plurality of grid servers, as containing the most current data, identifying the first partition on the first grid server as corresponding to the workload of the grid client, and querying the first grid server for the one or more resources from the first partition; and
responding, by the second grid server, to the request from the grid client.

2. (canceled)

3. The method of claim 1, wherein said determination to transfer the workload of the grid client from the first grid server to the second grid server comprises a determination, by the catalog server, that the first grid server is malfunctioning.

4. The method of claim 3, further comprising, responsive to the determination that the first grid server is malfunctioning, determining that the second grid server is available to act as a primary server.

5. The method of claim 1, wherein said determination to transfer the workload of the grid client from the first grid server to the second grid server comprises:
receiving at the catalog server a notification from the second grid server indicating that the second grid server has been added to the grid computing system.

6. The method of claim 1, further comprising:
sending an identification of the first grid server to the second grid server.

7. The method of claim 1, wherein the replication process transfers one or more data objects to the second grid server and application state.

8. The method of claim 1, further comprising:
receiving a second request at the second grid server from the grid client;
determining, by the second grid server, whether one or more resources necessary to handle the second request are current in the primary partition; and
responsive to determining that the one or more resources are current in the primary partition, the second grid server responding to the second request from the grid client.

9. The method of claim 1, wherein the first grid server and the second grid server are java virtual machines.

10. A system for transitioning a workload of a grid client from a first grid server to a second grid server, the system comprising:
one or more computer processors;
one or more computer readable media;
wherein the one or more computer processors and the one or more computer readable media are allocated to at least a first grid server process, a second grid server process, and a catalog server process;
program instructions stored on the one or more computer readable media for execution by at least one of the one or more computer processors, the program instructions comprising:
program instructions to, in response to a determination to transfer the workload of the grid client from the first grid server process to the second grid server process, wherein the first grid server process contains a plurality of separate partitions corresponding to different workloads including a first partition for the workload of the grid client, designate, by the catalog server process, a corresponding partition on the second grid server process as a primary partition for the workload of the grid client such that the second grid server process responds directly to requests from the grid client utilizing the primary partition and seeks data from the first partition on the first grid server process if a request cannot be completed due to the primary partition not having current live data;
program instructions to commence a replication process transferring data from the first partition on the first grid server process to the primary partition on the second grid server process;
program instructions to reroute the grid client to communicate with the second grid server process prior to the completion of the replication process;
program instructions to receive a request at the second grid server process from the grid client;
program instructions to determine, by the second grid server process, whether one or more resources necessary to handle the request are current in the primary partition corresponding to the workload of the grid client;
program instructions to, responsive to determining that the one or more resources are not current, based on an identity of the grid client and information received from the catalog server process, identify by the second grid server process, the first grid server process from a plurality of grid server processes as containing the most current data, identify by the second grid server process, the first partition on the first grid server process as corresponding to the workload of the grid client, and query, by the second grid server process, the first grid server process for the one or more resources from the first partition; and
program instructions to respond, by the second grid server process, to the request from the grid client.

11. (canceled)

12. The system of claim 10, wherein the determination to transfer the workload of the grid client from the first grid server process to the second grid server process comprises a determination, by the catalog server process, that the first grid server process is malfunctioning.

13. The system of claim 12, further comprising program instructions, stored on the one or more computer readable storage media, to, responsive to the determination that the first grid server process is malfunctioning, determine that the second grid server process is available to act as a primary server.

14. The system of claim 10, wherein the determination to transfer the workload of the grid client from the first grid server process to the second grid server process comprises program instructions to receive at the catalog server process a notification from the second grid server process indicating that the second grid server process has been implemented in the system.

15. The system of claim 10, further comprising program instructions, stored on the one or more computer readable storage media for execution by the one or more computer processors, to send an identification of the first grid server process to the second grid server process.

16. The system of claim 10, wherein the replication process transfers one or more data objects to the second grid server process and application state.

17. The system of claim 10, further comprising program instructions, stored on the one or more computer readable storage media for execution by the one or more computer processors, to:
receive a second request at the second grid server process from the grid client;
determine, by the second grid server process, whether one or more resources necessary to handle the second request are current in the primary partition; and
responsive to determining that the one or more resources are current in the primary partition, respond from the second grid server process to the second request from the grid client.

18. The system of claim 10, wherein the first grid server process and the second grid server process are java virtual machines.

19. A computer program product for transitioning a workload of a grid client from a first grid server to a second grid server, the computer program product comprising:
one or more computer readable media; and
program instructions stored on the one or more computer readable media, the program instructions comprising:
program instructions to, in response to a determination to transfer the workload of the grid client from the first grid server to the second grid server, wherein the first grid server contains a plurality of separate partitions corresponding to different workloads including a first partition for the workload of the grid client, designate, by a catalog server, a corresponding partition on the second grid server as a primary partition for the workload of the grid client such that the second grid server responds directly to requests from the grid client utilizing the primary partition and seeks data from the first partition on the first grid server if a request cannot be completed due to the primary partition not having current live data;
program instructions to commence a replication process transferring data from the first partition on the first grid server to the primary partition on the second grid server;
program instructions to reroute the grid client to communicate with the second grid server prior to the completion of the replication process;
program instructions to receive a request at the second grid server from the grid client;
program instructions to determine, by the second grid server, whether one or more resources necessary to handle the request are current in the primary partition corresponding to the workload of the grid client;
program instructions to, responsive to determining that the one or more resources are not current, based on an identity of the grid client and information received from the catalog server, identify by the second grid server, the first grid server from a plurality of grid servers as containing the most current data, identify by the second grid server, the first partition on the first grid server as corresponding to the workload of the grid client, and query, by the second grid server, the first grid server for the one or more resources from the first partition; and
program instructions to respond, by the second grid server, to the request from the grid client.

20. The computer program product of claim 19, further comprising program instructions, stored on the one or more computer readable storage media, to:
receive a second request at the second grid server from the grid client;
determine, by the second grid server, whether one or more resources necessary to handle the second request are current in the primary partition; and
responsive to determining that the one or more resources are current in the primary partition, respond from the second grid server to the second request from the grid client.
